(19) United States
(12) Patent Application Publication
(10) Pub. No.: US 2005/0226769 A1
(43) Pub. Date: Oct. 13, 2005

(54) Analytical apparatus and analytical disk for use therein

(75) Inventor: Takashi Shiga, Toon-shi (JP)

Correspondence Address: STEPTOE & JOHNSON LLP, 1330 CONNECTICUT AVENUE, N.W., WASHINGTON, DC, 20036, US

(73) Assignee: Matsushita Elec. Ind. Co. Ltd., Kadoma-shi (JP)

(21) Appl. No.: 11/101,403

(22) Filed: Apr. 8, 2005

(30) Foreign Application Priority Data
Apr. 8, 2004 (JP) 2004-113815

(51) Int. Cl. G01N 21/00

(52) U.S. Cl. 422/58; 422/82.05

(57) ABSTRACT

In an analytical apparatus in which an analytical disk having sampled therein a test sample is rotated and the reaction with a reagent provided in a channel is optically analyzed, offset adjustment or gain adjustment of a photodetector of the analytical apparatus can be carried out automatically even with analytical disks of different types having various channel shapes. Position information relating to adjustment and reference values of the adjustment level are recorded in a track area of an analytical disk. Based on such information, the analytical apparatus conducts the offset and gain adjustment of the photodetector in a prescribed area of the analytical disk. As a result, the adjustment can be conducted automatically even when analytical disks having channels of various shapes are installed in the analytical apparatus.

### BACKGROUND OF THE INVENTION

1. Field of the Invention

The present invention relates to an analytical apparatus designed to set a test sample such as blood or urine in an optical disk for analysis and to analyze the components present in the test sample by tracing the test sample, and to an analytical disk to be used in the analytical apparatus.

2. Description of the Related Art

An apparatus is known (see, for example, JP 10-504397 W) in which an analysis object is analyzed by using a compact disk having audio or video information recorded therein and a reproduction function of an optical disk drive for reproducing the disk and tracking the tracks of the analytical disk having a test sample disposed therein.

First, an analytical disk configured to sample a test sample by employing an optical disk will be described with reference to FIG. 6.

Referring to FIG. 6, an analytical disk 100 is formed according to the standards relating to the conventional optical disks, such as designed for recording audio or video information, and comprises a track area 101 having address information and formed by pits, grooves, etc. present in the conventional optical disks. Furthermore, the analytical disk 100 has an analytical area 102a for analyzing a test sample such as blood or urine, and the test sample is introduced into a channel 104 formed inside the analytical disk through an injection opening 105a and collected therein. A reagent for reacting with the test sample can be also disposed in the channel 104. The analysis is conducted in a region A shown by hatching in the channel 104 of the figure.

As for the measurement timing for conducting the analysis, the position of region A is specified by the time that elapsed after a marking 103a has been detected (for example, see portion of JP 2003-270128 A where marks are explained).

The analytical apparatus using the analytical disk of the above-described configuration will be explained below with reference to FIG. 3 and FIG. 6. Referring to FIG. 3, the analytical apparatus comprises an optical pickup 20, a traverse motor 21 for moving the optical pickup, a spindle motor 22 for rotating the disk, a CPU 23 for controlling those components, a servo control circuit 24, and a signal processing circuit 25 for converting the signals from the optical pickup 20 into data, this configuration being identical to that of the conventional optical disk apparatus. There are further comprised a photodetector 11 for detecting the transmitted beam of a laser emitted from the optical pickup 20, an adjustment circuit 12 for changing the signal level of the photodetector 11, an A/D converter 13 for A/D converting the detected signal, a signal processing circuit 14 for processing the A/D converted data, a RAM 16 for storing the data, a CPU 15 for controlling those components, and a photosensor 17 for detecting the marking 103a provided on the analytical disk 100.

The analysis method using the analytical disk and analytical apparatus will be described bellow. First, a test sample that is to be analyzed is injected from the injection opening 105a of the analytical disk 100. Then, the analytical disk 100 is placed in the analytical apparatus and disk discrimination conducted in the conventional optical disk apparatuses and spin-up processing such as focus-on and tracking-on are conducted, thereby enabling the tracing of the tracks provided on the analytical disk 100.

If the analysis of the test sample is started, the number of movement tracks from the present position of the optical pickup 20 and the position where the analytical area 102a is present is computed, the optical pickup 20 is moved to the analytical area 102a based on the computed number of movement track, and the track is traced from the location to which the optical pickup was moved. Then, the marking 103a provided in the analytical disk 100 is detected with the photosensor 17. The transmitted light from the optical pickup is detected by the photodetector 11 in the specific position after the prescribed timing from the signal detected by the photosensor 17, the detected light is A/D converted with the A/D converter 13, and the data obtained is stored in the RAM 16. The analysis results of the test sample can be obtained based on this acquired data.

Here, a spread in the signal detected by the photodetector 11 appears due to the difference in the signal levels detected for each test sample that is to be analyzed, eccentricity of each analytical disk, and deviation of center of gravity. For this reason, offset and gain adjustment are necessary to adjust the detected signal to the signal level that can be acquired as data by the A/D converter 13. The offset adjustment is conducted by setting the prescribed reference value and changing the parameters of the adjustment circuit 12 for adjusting the signal level so as to bring them closer to the reference, while monitoring the data acquired from the photodetector 11. Similarly, the gain adjustment is conducted by setting the prescribed reference range and changing the parameters of the adjustment circuit 12 so as to bring them closer to the reference range.

In order to configure an optical disk to make it adaptable to a variety of analysis targets or test samples, the channel shape or arrangement of the reagent in the analytical area where the test samples are collected has to be changed. If the arrangement of the reagent or channel shape differs, the adjustment processing has to be conducted in different positions for each type of the analytical disk to conduct the offset and gain adjustment of the above-described photodetector in the position where the test sample is present or in the adjustment area determined by the disk.

However, the above-described conventional analytical apparatus is designed for analytical disks with identical reagent arrangements and channel shapes, and the offset and gain adjustment can be conducted only in the same position. In other words, the configuration is not suitable for conducting the adjustment processing such as offset and gain adjustment with respect to a variety of analytical disk. Therefore, when analytical disks with different channel shapes are planned to be produced, freedom of design is restricted due to limitations placed on the arrangement of channels for which the offset and gain adjustment has to be conducted.

### SUMMARY OF THE INVENTION

It is an objective of the present invention to resolve the above-described conventional problems associated with the adjustment of the photodetector for detecting an analysis object and to realize the adjustment of the photodetector to various analytical disks in one analytical apparatus.

In order to resolve the above-described conventional problems, the present invention provides an analytical apparatus designed for installing therein an analytical disk comprising an analytical area where a test sample to be analyzed can be collected and a marking corresponding to the analytical area. Position control is conducted for an optical unit for illuminating the installed analytical disk with a light beam in the radial direction of the analytical disk, while rotatively driving the analytical disk, and the test sample is analyzed by detecting the reflected light or transmitted light from the analytical area at a prescribed timing after detecting the marking, in a state where the position control has been conducted in the radial direction. Prior to the analysis, position information indicating a specific position provided on the analytical disk in advance is acquired, the position control of the optical pickup in the radial direction is conducted based on the acquired position information, and the offset or gain of a photodetector is adjusted in the specific position after the prescribed timing after the marking has been detected.

The analytical disk in accordance with the present invention comprises an analytical area where a test sample to be analyzed can be collected and a marking corresponding to the analytical area, wherein this disk comprises position information indicating the position in the radial direction of the analytical disk and a specific position for conducting offset or gain adjustment specified by the timing from the marking.

In contrast with the conventional analytical apparatus adaptable only to one analytical disk, the analytical apparatus and analytical disk according to the present invention can conduct automatic offset and gain adjustment with respect to various analytical disks, by conducting the adjustment of the photodetector for detecting an analysis object in a specific area of the analytical disk corresponding to the analysis object.

### BRIEF DESCRIPTION OF THE DRAWINGS

FIG. 1 is a plan view of an analytical disk according to Embodiment 1 of the present invention;

FIG. 2 is a plan view of an analytical disk according to Embodiment 2 of the present invention;

FIG. 3 is a configuration drawing illustrating the analytical apparatus according to Embodiments 1 and 2 of the present invention;

FIG. 4 is a plan view of an analytical disk according to Embodiment 3 of the present invention;

FIG. 5 is a configuration drawing illustrating the analytical apparatus according to Embodiment 3 of the present invention; and

FIG. 6 is a plan view illustrating a conventional analytical disk.

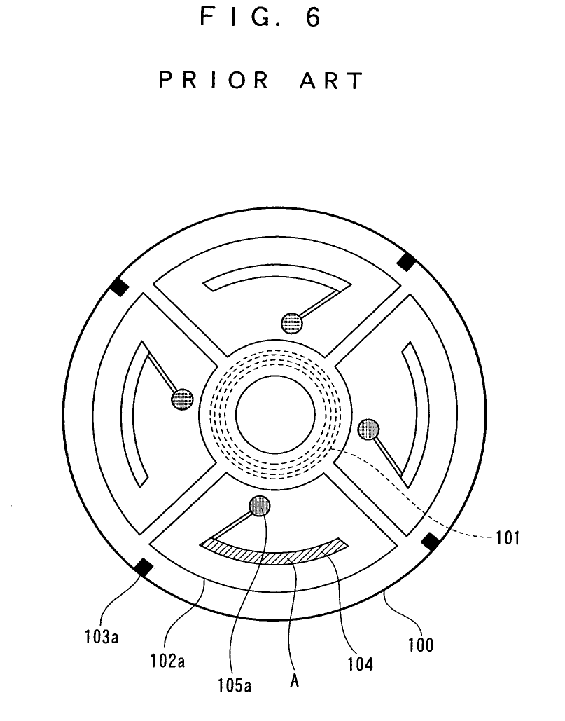

### DESCRIPTION OF THE PREFERRED EMBODIMENTS

The embodiments of the present invention will be described below in greater detail with reference to embodiments thereof.

### Embodiment 1

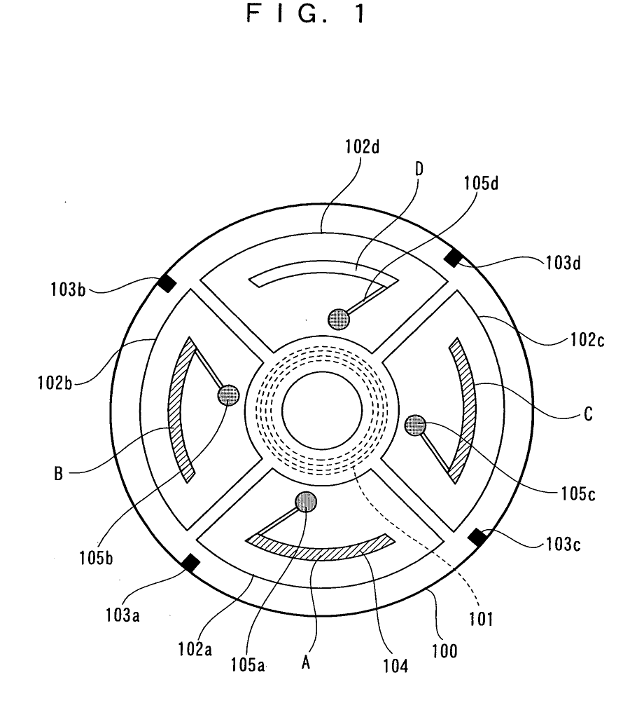

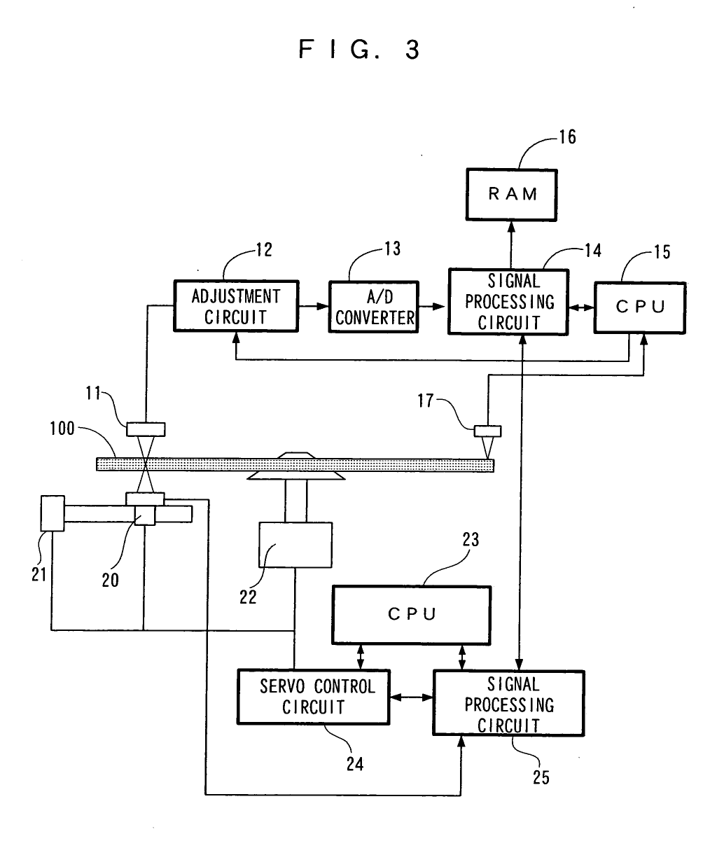

FIG. 1 is a plan view of an analytical disk in Embodiment 1 of the present invention. FIG. 3 is a configuration drawing illustrating the analytical apparatus in Embodiment 1 of the present invention.

First, a schematic flow of offset and gain adjustment will be explained. A test sample that is wished to be analyzed is injected from injection openings 105a, 105b, 105c, 105d into four analytical areas 102a, 102b, 102c, 102d of an analytical disk 100, and this analytical disk 100 is mounted on an analytical apparatus. The analytical apparatus acquires information relating to the analytical disk 100 that was recorded in a track area 101 of the mounted analytical disk 100.

The acquired information comprises position information (information relating to adjustment area) for executing offset and gain adjustment of a photodetector 11. The position information includes the movement quantity for moving an optical pickup 20 in the radial direction of the analytical disk 100 or the prescribed time till the analytical areas A, B, C, D are present after the markings 103a, 103b, 103c, 103d indicating the initial position of the analytical area has been detected. Offset and gain adjustment is conducted in the specific position of the analytical disk based on this position information.

Further, in addition to the position information, the information recorded on the analytical disk 100 also includes adjustment information such as the prescribed standard values or prescribed standard ranges for conducting offset and gain adjustment. The analytical disk can implement the offset and gain adjustment corresponding to respective analytical disk by acquiring this information and conducting the adjustment of the photodetector 11 based thereon.

Here, the offset and gain adjustment is conducted after the test sample has been introduced into the analytical disk 100. This is done in order to conduct the analysis of the test sample after the test sample has been introduced into the disk, because the offset and gain adjustment has to be conducted in this state.

Here, the case of an analytical disk for conducting only the offset adjustment will be described in greater details as a specific example.

In four analytical areas 102a, 102b, 102c, 102d of the analytical disk 100, of the respective regions A, B, C, D for conducting the analysis, the regions A, B, C have disposed therein a reagent for reacting with the test sample, and only the region D has no reagent disposed therein. The region D is recorded as information in the track area 101 of the analytical disk 100 as a position for conducting the offset adjustment of the analytical disk 100.

No reagent is disposed in the region D, which is the position for conducting offset adjustment, because when the reaction of the test sample and the reagent is analyzed, for example, when analysis is conducted by changes in colorants, only the test sample has to be taken as the reference and the offset adjustment has to be conducted in the location of the reference.

The analytical disk changes the parameters for offset adjustment of an adjustment circuit 12 in the region D and conducts processing for matching the signal level of the photodetector 11 with the prescribed reference value. Further, the gain adjustment is not particularly necessary because when the analysis object is the change in the colorants, the reactions occurring in each of the analytical regions A, B, C change uniformly over the entire respective regions. Therefore, adjustment processing is hereby completed and the analysis is started.

The analysis is conducted by performing A/D conversion of the signal level of the photodetector 11 in the regions A, B, C comprising the test samples that have reacted with the reagent and acquiring the results as data. The reaction of the reagent with the test samples to be analyzed is analyzed based on the acquired data.

### Embodiment 2

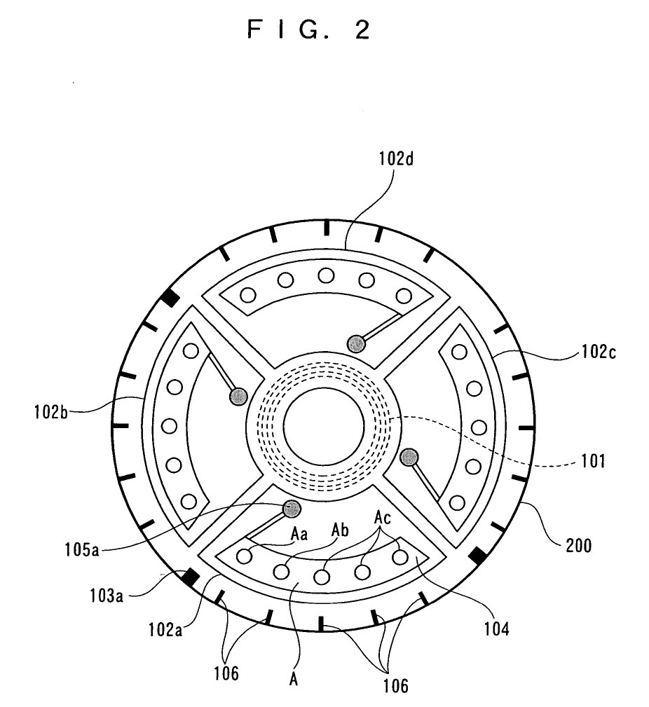

FIG. 2 is a plan view of the analytical disk in Embodiment 2. Components substantially identical to those of the analytical disk described in Embodiment 1 are assigned with the same symbols and explanation thereof is omitted. The difference between this analytical disk and the analytical disk explained in Embodiment 1 is in that a plurality of different analysis are conducted in each analytical areas and in that a trigger mark is formed in addition to the markings indicating the start position of the analytical area in each analytical area. Further, the apparatus shown in FIG. 3 can be used as the analytical apparatus, in the same manner as in Embodiment 1.

Referring to FIG. 2, respective trigger marks 106 of an analytical disk 200 are disposed in positions corresponding to a variety of reagents that will react with the test sample present in the analytical area 102a, and the position where the reagent is present can be specified based on the trigger mark 106.

Information recorded on the analytical disk 200 is almost identical to that explained in Embodiment 1 and includes the position information on the adjustment area, the prescribed reference values for offset and gain adjustment, and the prescribed reference range. The difference is in that the information for specifying the position of the trigger mark 106 is recorded, whereas with respect to the position information on the adjustment area, the analytical disk shown in FIG. 2 is a disk provided with the trigger mark 106 corresponding to the reagent, as described hereinabove, and therefore the position information relating to the prescribed interval from the detection of a marking 103a indicating the start position of the analytical area to the presence of the analytical region, as in the analytical disk shown in FIG. 1, is unnecessary. The offset and gain adjustment of the photodetector 11 can be implemented in the same manner as in Embodiment 1 based on the information relating to offset and gain adjustment that was recorded on the analytical disk 200.

A method for adjusting the offset and gain of the analytical disk 200 shown in FIG. 2 will be explained below. The explanation will be conducted with respect to the case where this analytical disk 200 is used for conducting analysis by inducing the reaction of cells present in the test sample with reagents, causing the adsorption of the target cells in any location (that is, in the position of respective reagents), and counting the number of the cells.

If a blood sample is injected from the injection opening 105a and the disk is rotated, the sample successively moves through a channel 104 to Aa, Ab, Ac and spreads till the end portion is reached. Among the regions for conducting the analysis, Aa forms a reagent that does not react with target cells, Ab forms a reagent that necessarily reacts with the target cells, and Ac forms a reagent for analyzing the reaction with the target cells, thereby making it possible to conduct analysis of various reactions of the cells and the reagents.

Here, the region Aa where the reagent that does not react with the target cells is present is taken as an offset adjustment area. The region Aa is taken as an offset adjustment area because this portion is taken as a reference for analyzing the reaction of the test sample and the reagent. In this position the parameters of the adjustment circuit 12 are changed and the signal level of the photodetector 11 is matched with the prescribed reference value.

As for the gain adjustment, he region Ab where the reagent that necessarily reacts with the target cells is present is taken as a gain adjustment area. The region Ab is taken as a gain adjustment area because the gain adjustment is normally not conducted unless the target cells are present in the position where the gain adjustment is conducted. If this region Ab is detected with the photodetector 11, a signal level is detected that has greatly changed with respect to the reference value that was adjusted by the offset adjustment in the location where the target cells are present. The parameters of the adjustment circuit 12 are varied and gain adjustment is conducted so that this change quantity enters the prescribed reference range. The offset and gain adjustment is thereby completed and the reaction of the cells and reactant finally can be analyzed by detecting the region Ac with the photodetector 11.

Further, in the analytical disk 200, the above-described analysis can be conducted in the analytical areas 102b, 102c, 102d and four cycles of analysis can be conducted with this one analytical disk.

### Embodiment 3

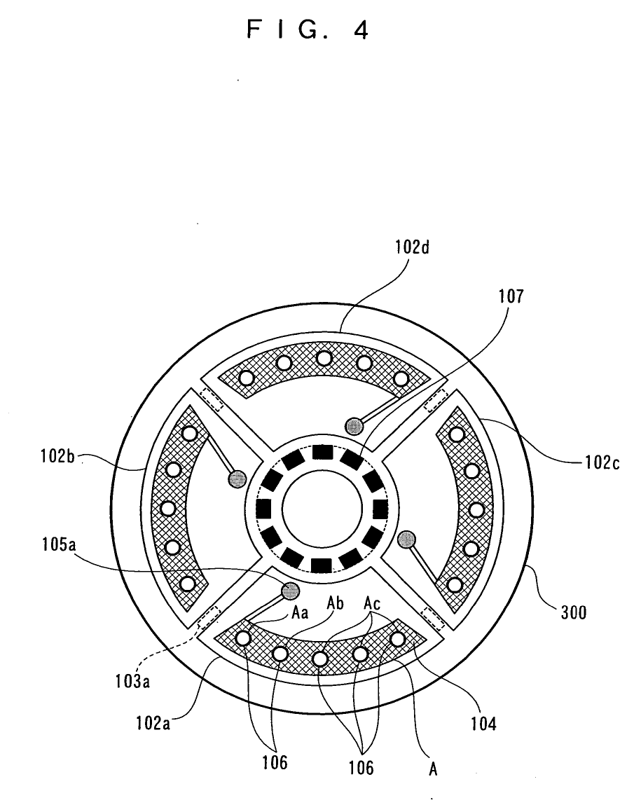

FIG. 4 is a plan view of the analytical disk in Embodiment 3. Components substantially identical to those of the analytical disk described in Embodiment 2 are assigned with the same symbols and explanation thereof is omitted. The difference between this analytical disk and the analytical disk explained in Embodiment 2 is in that the track area 101 explained in Embodiment 2 is absent and the position information or adjustment information that is the information relating to the analytical disk, and identification information that identifies the type of the analytical disk are provided at a barcode 107 comprised in the analytical disk, recesses provided locally in the analytical disk serve as markings corresponding to the analytical area, and a trigger mark is disposed in the analytical region.

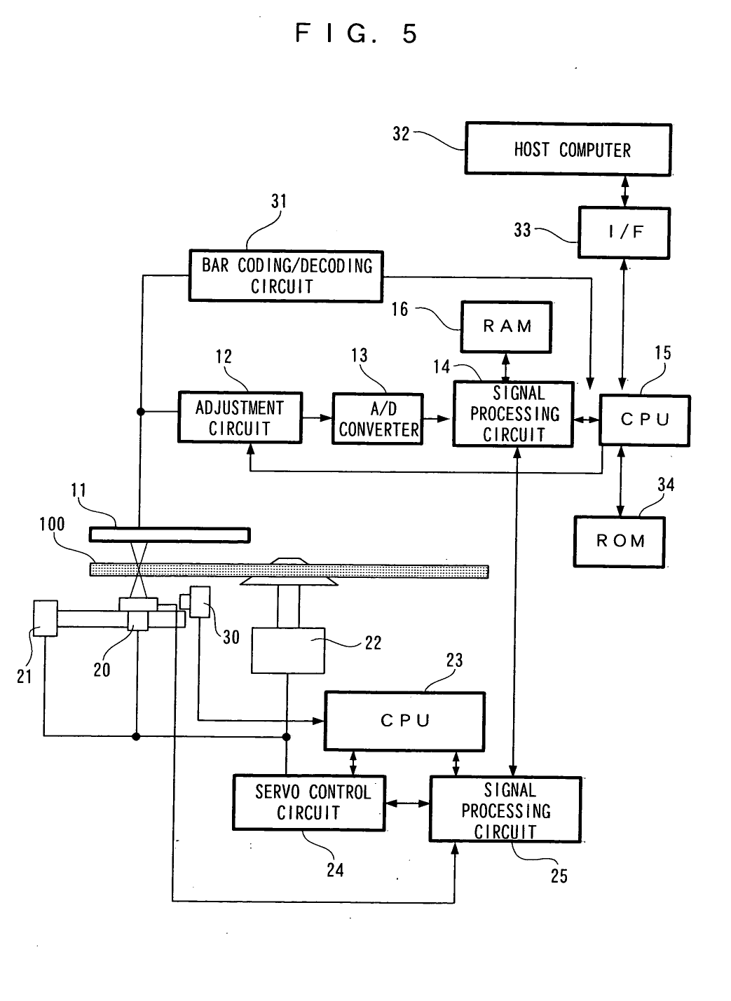

FIG. 5 is a configuration drawing illustrating the analytical apparatus in Embodiment 3 of the present invention. Components substantially identical to those of the analytical apparatus described in Embodiment 1 are assigned with the same symbols and explanation thereof is omitted. The difference between this analytical apparatus and the analytical apparatus explained in Embodiment 1 is in that it comprises a position detection switch 30 indicating the reference position of the optical pickup, a bar coding/decoding circuit 31 for acquiring information from the barcode, an interface 33 for enabling signal exchange between the analytical apparatus and a host computer 32, and a ROM 34 as a storage region inside the analytical apparatus.

As for the barcode 107 disposed in the prescribed position of the analytical disk 300, the optical pickup 20 is position controlled to a position where the barcode 107 is present, and the signal of transmitted light outputted from the photodetector 11 is data converted in the bar coding and decoding circuit 31 and converted into information relating to the analytical disk in the CPU 15.

Here, the position control of the optical pickup 20 is conducted by moving the position detection switch 30, which indicates the reference position of the optical pickup 20, till it is detected by the CPU 23 and moving through the prescribed distance from this reference position. In particular, if a traverse motor 21 is a stepping motor that is a motor suitable for moving to the prescribed position, the position control with a higher positional accuracy can be realized.

The information relating to the analytical disk 300 that was acquired from the barcode 107 is almost identical to that explained in Embodiment 2 and represents the position information on the adjustment area or the adjustment information indicating the prescribed reference value or prescribed reference range of the gain adjustment. The difference is that the position information in the radial direction of the adjustment area is the amount of movement from the above-described reference position of the optical pickup 20. The offset and gain adjustment of the photodetector 11 can be implemented in the same manner as in Embodiment 2 from the barcode information comprises in the analytical disk 300.

In contrast with Embodiment 1 or Embodiment 2, the detection of the trigger mark 106 or marking 103a corresponding to the analytical area 102a in the analytical disk 300 shown in FIG. 4 is conducted with the optical pickup 20 and photodetector 11.

More specifically, the marking 103a corresponding to the analytical area 102a is a recess. When the laser beam from the optical pickup 20 illuminates the recess provided locally in the analytical disk 300 and the transmitted light is acquired as a signal by the photodetector 11, this transmitted light is caused to change in the reflection conditions or light refraction, which causes the signal detected by the photodetector 11 to change due to the effect of the recess. Thus, this signal is detected as a marking signal.

Further, the disposition location and shape of the trigger mark 106 are different from those of the trigger mark 106 of Embodiment 2, but they are similar in that they are printed on the surface of the analytical disk 300 and because the printed portion interrupts the transmitted light, the signal of the photodetector 11, which detects the transmitted light, changes and the changes are detected as a trigger mark signal.

The offset and gain adjustment of the photodetector 11 in the specific position of the analytical disk 300 can be implemented by detecting the making and trigger mark or conducting position control from the reference position of the optical pickup 20 based on the adjustment information or position information acquired from the analytical disk 300.

The explanation of the method for adjusting the offset and gain of the analytical disk 300 is identical to that of Embodiment 2 and is, therefore, omitted.

By providing identification information for identifying the type of the analytical disk 300 as acquired information from the analytical disk 300, it becomes possible to store the adjustment information or position information relating to the adjustment area in the analytical apparatus or in the external device connected to the analytical apparatus and to acquire the adjustment information or position information relating to the adjustment area corresponding to the analytical disk by using the identification information.

More specifically, the analytical apparatus sends the identification information for identifying the type of the analytical disk that was acquired from the barcode 107 to the host computer 32 via the interface 33 and receives from the host computer 32 the adjustment information or position information relating to the adjustment area based on the identification information. The offset and gain adjustment of the photodetector 11 in the specific position of the analytical disk can be implemented based on this information.

Further, the adjustment information or position information relating to the adjustment area for each analytical disk is recorded in the ROM 34 of the analytical apparatus, and the offset and gain adjustment of the photodetector 11 in the specific position of the analytical disk can also be implemented by selecting the adjustment information or position information relating to the adjustment areas based on the identification information for identifying the type of the analytical disk that was acquired from the barcode 107.

As for the above-mentioned method for acquiring the adjustment information or position information relating to the adjustment area corresponding to the analytical disk, the acquisition method identical to that of Embodiment 1 and Embodiment 2 can also be implemented by recording the identification information for identifying the type of the analytical disk in the track area explained in Embodiment 1 or Embodiment 2.

With the analytical apparatus in accordance with the present invention, the adjustment of the photodetector serving to detect the analysis object is conducted in the prescribed area of the analytical disk corresponding to the analysis object, whereby an analytical apparatus and analytical disk adapted for adjustments of various analytical disks can be provided.

1. An analytical apparatus, comprising:
an analytical disk comprising an analytical area for collecting therein a test sample to be analyzed and a marking corresponding to said analytical area; and
an optical unit for illuminating said analytical disk with a light beam, said optical unit being subjected to position control in the radial direction of said analytical disk while rotatively driving said analytical disk;
said test sample being analyzed by detecting reflected light or transmitted light from said analytical area at a prescribed timing after detecting said marking, with said optical unit having been subjected to the position control in said radial direction, wherein
prior to said analysis, position information indicating a specific position previously provided on the analytical disk is acquired, the position control of said optical pickup in the radial direction is conducted based on the acquired position information, and adjustment of offset or gain of a photodetector is conducted at the specific position after the prescribed timing after the detection of said marking.

2. The analytical apparatus according to claim 1, wherein
said analytical disk has a plurality of trigger marks formed in said analytical area separately from said markings, and prior to said analysis, position information indicating a specific position previously provided on the analytical disk is acquired, the position control of said optical pickup in the radial direction is conducted based on the acquired position information, and adjustment of offset or gain of a photodetector is conducted at the specific position after the prescribed trigger mark has been detected after the detection of said markings.

3. The analytical apparatus according to claim 1, wherein said markings or trigger marks are detected with said optical pickup.

4. The analytical apparatus according to claim 1, wherein a photodetection device for detecting said markings or trigger marks is provided separately from said optical pickup.

5. An analytical disk comprising an analytical area for collecting therein a test sample to be analyzed and a marking corresponding to said analytical area, wherein
said disk further comprises position information indicating a position in the radial direction of said analytical disk and a specific position for conducting offset or gain adjustment specified by a timing from said marking.

6. The analytical disk according to claim 5, wherein a plurality of trigger marks are formed correspondingly to the analytical area separately from said marking, said disk comprising position information indicating the position in the radial direction and a specific position specified by said marking and said trigger marks in number.

7. The analytical disk according to claim 5, further comprising adjustment information indicating a reference value or reference range for the offset or gain adjustment.

8. The analytical disk according to claim 5, wherein the position information indicating said specific position and the adjustment information indicating the reference value or reference range for the offset or gain adjustment are provided as barcodes.

9. The analytical apparatus according to claim 1, wherein offset or gain adjustment is conducted based on said position information or said adjustment information.

10. The analytical disk according to claim 8, further comprising identification information for identifying the type of said analytical disk.

11. An analytical apparatus comprising the analytical disk according to claim 10, wherein said adjustment information or said position information indicating said specific position corresponding to said analytical disk is selected based on said identification information to conduct offset or gain adjustment of a photodetector.

12. The analytical apparatus according to claim 9, wherein said adjustment information and said position information indicating said specific position are provided from an external apparatus connected to said analytical apparatus, and offset or gain adjustment of a photodetector is conducted based on said position information or adjustment information thus provided.

13. The analytical apparatus according to claim 9, wherein said adjustment information and said position information indicating said specific position is stored in a storage device provided inside said analytical apparatus, and offset or gain adjustment of a photodetector is conducted based on said adjustment information or position information indicating said specific position thus stored.

14. An analytical apparatus, comprising:
an analytical disk including an analytical area for collecting therein a test sample to be analyzed, a track area having a track for recording therein address information, and a marking corresponding to said analytical area;
said analytical disk being illuminated with a light beam, while rotatively driving said analytical disk, and the light reflected from said analytical disk being detected by an optical pickup, thereby to acquire address information on said track area;
said optical pickup being subjected to position control in the radial direction of said analytical disk based on said acquired address information;
said test sample being analyzed by detecting the reflected light or transmitted light from said analytical area at a prescribed timing after detecting said marking, with said optical unit having been subjected to the position control in said radial direction, wherein
prior to said analysis, position information indicating a specific position previously recorded on the analytical disk is acquired, the position control of said optical pickup in the radial direction is conducted based on the acquired said position information, and adjustment of offset or gain of a photodetector is adjusted at the specific position after the prescribed timing after said marking has been detected.

15. The analytical apparatus according to claim 14, wherein said analytical disk has a plurality of trigger marks formed in said analytical area separately from said markings, and prior to said analysis, position information indicating a specific position previously recorded on the analytical disk is acquired, the position control of said optical pickup in the radial direction is conducted based on the acquired position information, and adjustment of offset or gain of a photodetector is conducted at the specific position after the prescribed trigger mark has been detected after the detection of said markings.

16. The analytical apparatus according to claim 14, wherein said markings or trigger marks are detected with said optical pickup.

17. The analytical apparatus according to claim 14, wherein a photodetection device for detecting said markings or trigger marks is provided separately from said optical pickup.

18. An analytical disk comprising an analytical area for collecting therein a test sample to be analyzed, a track area having a track for recoding therein address information, and a marking formed in a positional relationship corresponding to said analytical area, wherein
said track area comprises position information indicating a position in the radial direction specified by the address information and a specific position in the analytical area indicating a position for conducting offset or gain adjustment specified by the timing from the marking.

19. The analytical disk according to claim 18, wherein a plurality of trigger marks are formed in the analytical area separately from said marking, and said track area comprises the position information indicating a position in the radial direction specified by the address information and a specific position specified by the trigger marks in number from said marking.

20. The analytical disk according to claim 18, wherein said track area further comprises adjustment information indicating a reference value or reference range for the offset or gain adjustment.

21. The analytical disk according to claim 18, wherein the position information indicating said specific position or the adjustment information indicating the reference value and the reference range for the offset or gain adjustment are recorded on said analytical disk.

22. The analytical apparatus according to claim 14, wherein the offset or gain adjustment is conducted based on said position information or said adjustment information.

23. The analytical disk according to claim 21, further comprising identification information for identifying the type of said analytical disk.

24. An analytical apparatus comprising the analytical disk according to claim 23, wherein said adjustment information or said position information indicating said specific position corresponding to said analytical disk is selected based on said identification information to conduct offset or gain adjustment of a photodetector.

25. The analytical apparatus according to claim 22, wherein said adjustment information or said position information indicating said specific position are provided from an external apparatus connected to said analytical apparatus, and offset or gain adjustment of a photodetector is conducted based on said position information or adjustment information thus provided.

26. The analytical apparatus according to claim 22, wherein said adjustment information or position information indicating said specific position is stored in a storage device provided inside said analytical apparatus, and offset or gain adjustment of a photodetector is conducted based on said adjustment information or position information indicating said specific position thus stored.
